(19) United States
(12) Patent Application Publication
(10) Pub. No.: US 2001/0024428 A1
(43) Pub. Date: Sep. 27, 2001

(54) Multi-way multiplex communication system and method of assigning channel in the same

(75) Inventor: Takakazu Onouchi, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/812,840

(22) Filed: Mar. 21, 2001

(30) Foreign Application Priority Data
Mar. 21, 2000 (JP) 078507/2000

(51) Int. Cl. H04J 3/02

(52) U.S. Cl. 370/329; 370/537

(57) ABSTRACT

A multi-way multiplex communication system includes (a) a subsidiary station covering terminals to each of which an analog line, a basic rate interface (BRI) line and a primary rate interface (PRI) line are connected, and (b) a base station which assigns the requisite number of time slots to thereby make radio communication with the subsidiary station in dependence on vacant time slots between the subsidiary station and the base station. The base station defines a subscriber class which determines an order in using a time slot to make radio communication with a H-channel terminal, monitors vacant time slots on receipt of a request of making a call, from the H-channel terminal, and controls call connection, based on the subscriber class, when it is impossible to connect a call because of shortage of vacant time slots, thereby ensuring a time slot for the H-channel terminal to make radio communication between the subsidiary station and the base station.

### BACKGROUND OF THE INVENTION

1. Field of the Invention

The invention relates to a multi-way multiplex communication system, and more particularly to a multi-way multiplex communication system including a subsidiary station covering terminals to each of which an analog line, a basic rate interface (BRI) line and a primary rate interface (PRI) line are connected, and a base station which assigns the requisite number of time slots to thereby make radio communication with the subsidiary station in dependence on the number of vacant time slots between the subsidiary station and the base station.

The invention relates further to a method of assigning a channel in a multi-way multiplex communication system.

2. Description of the Related Art

In a conventional multi-way multiplex communication system, communication between a base station and a subsidiary station in telephone service including integrated services digital network (ISDN) is carried out in a demand assign process where a channel is assigned when a call is made and a channel is released when communication has been finished. The demand assign process has been developed for enhancement in a usage efficiency of a channel.

For instance, Japanese Unexamined Patent Publication No. 10-322758 has suggested a method of assigning a channel in a demand assign type multi-way multiplex communication system.

FIG. 1 is a block diagram of a demand assign type multi-way multiplex communication system disclosed in the Publication.

The illustrated multi-way multiplex communication system includes a base station 2a and a subsidiary station 3a. The base station 2a is connected to a public network 1. The subsidiary station 3a is connected to a first terminal 61, and further to a second terminal 62 through a network terminator 1 (NT1) (71).

With reference to FIG. 1, it is assumed that the first terminal connected to the subsidiary station 3a through an analog line makes a call to the second terminal 62 connected to the subsidiary station 3a through a basic rate interface line.

When the first terminal 61 dials to the second terminal 62, time slots for D and B channels are assigned to communication between the first and second terminals 61 and 62. Layer 3 message is transmitted from the first terminal 61 to the public network 1 through the assigned D-channel time slot, and thus, communication is established.

Voices are transmitted from the first terminal 61 to the public network 1 through the assigned B-channel time slot.

In receipt of a call in the second terminal 62, the base station 2a assigns D-channel and B-channel time slots when the base station 2a detects the call, and then, a process for the second terminal 62 to receive a call is carried out. When the second terminal 62 respond to a call, communication between the first terminal 61 and the network terminator 1 (71) is established.

If the above-mentioned conventional multi-way multiplex communication system is intended to include an ISDN primary rate interface for accomplishing H-channel communication, it would be necessary to capture a lot of time slots at a time. However, since an analog line and an ISDN primary rate interface line are higher in traffic than H-channel communication, it would be quite difficult to capture the requisite number of time slots.

Accordingly, a subscriber has to repeatedly dial in order to capture requisite time slots.

If channels to be used only for H-channel communication are increased between the subsidiary station 3a and the base station 2a, it would be possible to surely capture requisite time slots. However, since H-channel communication is lower in traffic than telephone or fax communication, a line usage efficiency would be enhanced by not mixing H-channel communication with telephone and fax lines.

Japanese Unexamined Patent Publication No. 5-68274 has suggested a system for capturing a H-channel time slot, where a request of connecting a H-channel call to ISDN exchange system is received from a primary rate interface in an interface between a user and a network, and the ISDN exchange system captures the requisite number of time slots for making a H-channel call. The suggested system includes first means, when the ISDN exchange system could not capture the requisite number of time slots, for storing a number of time slots being now used and having not been captured and a number of vacant time slots having been captured, into a memory, second means for detecting that the used time slots are turned vacant, third means for prohibiting the vacant time slots from being captured by another call, and fourth means for detecting that the time slots stored in the memory as time slots now being used are all turned vacant, and informing a terminal that it is now possible to make communication when the terminal requests a H-channel call.

Japanese Unexamined Patent Publication No. 9-284873 has suggested a method of selecting a channel in an ISDN line, where a plurality of B-channels is used as a H-channel, and each of B-channels belongs to a first class where the B-channel is used only as a H-channel, or a second class where the B-channel may be used as a H-channel and as another channel. The suggested method includes the steps of temporarily turning B-channel into the first class, if the B-channel in the second class is being used when a request of making H-channel connection is received from a calling party, waiting until the B-channel becomes vacant, making H-channel communication with the calling party when the B-channel has become vacant, and turning the first class back into the first class when connection has been established.

However, the above-mentioned problems remain unsolved even in the above-mentioned Publications.

### SUMMARY OF THE INVENTION

In view of the above-mentioned problems in the conventional systems, it is an object of the present invention to provide a multi-way multiplex communication system which is capable of efficiently capturing H-channel time slots in lines including telephone and fax lines.

It is also an object of the present invention to provide a method of assigning a channel in a multi-way multiplex communication system.

In one aspect of the present invention, there is provided a multi-way multiplex communication system including (a) a subsidiary station covering terminals to each of which an analog line, a basic rate interface (BRI) line and a primary rate interface (PRI) line are connected, and (b) a base station which assigns the requisite number of time slots to thereby make radio communication with the subsidiary station in dependence on the number of vacant time slots between the subsidiary station and the base station, wherein the base station (b1) defines a subscriber class which determines an order in using a time slot to make radio communication with a H-channel terminal, (b2) monitors vacant time slots on receipt of a request of making a call, from the H-channel terminal, and (b3) controls call connection, based on the subscriber class, when it is impossible to connect a call because of shortage of vacant time slots, thereby ensuring a time slot for the H-channel terminal to make radio communication between the subsidiary station and the base station.

There is further provided a multi-way multiplex communication system including (a) a subsidiary station covering terminals to each of which an analog line, a basic rate interface (BRI) line and a primary rate interface (PRI) line are connected, and (b) a base station which assigns the requisite number of time slots to thereby make radio communication with the subsidiary station in dependence on the number of vacant time slots between the subsidiary station and the base station, the subsidiary station including an informer which informs a H-channel terminal of whether a call can be made, based on information received from the base station, the base station including (b1) a time slot manager which manages the vacant time slots, (b2) a subscriber data manager which defines a subscriber class for each of terminals which subscriber class determines an order in using a time slot to make radio communication with a H-channel terminal, (b3) an input device through which the subscriber class is input to the subscriber data manager, and (b4) a time slot capture controller which, when it is impossible to make a call because of shortage of vacant time slots, controls a time slot, based on the subscriber class.

For instance, the time slot capture controller (c1) gives up assigning a time slot, (c2) waits until one of time slots becomes vacant, (c3) or mandatorily interrupts a channel of a subscriber now in communication to thereby make a vacant time slot, in accordance with the subscriber class.

In another aspect of the present invention, there is provided a method of assigning a channel in a multi-way multiplex communication system including (a) a subsidiary station covering terminals to each of which an analog line, a basic rate interface (BRI) line and a primary rate interface (PRI) line are connected, and (b) a base station which assigns the requisite number of time slots to thereby make radio communication with the subsidiary station in dependence on the number of vacant time slots between the subsidiary station and the base station, the method comprising the steps of (a) storing a subscriber class into the base station for each of terminals, the subscriber class determining an order in using a time slot to make radio communication with a H-channel terminal, (b) monitoring vacant time slots on receipt of a request of making a call, from a terminal belonging to a first class among the subscriber class, the step (b) being to be carried out by the base station, (c) informing the subsidiary station that it is impossible to assign a time slot, when a call cannot be made because of shortage of vacant time slots, the step (c) being to be carried out by the base station, and (d) informing the H-channel terminal of inability of making a call, the step (d) being to be carried out by the subsidiary station.

It is preferable that the method further includes the steps of (e) informing the subsidiary station that the base station waits being assigned a time slot, on receipt of a request of making a call, from a terminal belonging to a second class among the subscriber class, the step (e) being to be carried out by the base station, (f) recording and reserving presently vacant time slots, which are not captured even if a request of making a call is received from a terminal belonging to the first and second classes, the step (f) being to be carried out by the base station, (g) monitoring time slots now being used, and capturing a time slot having been released after communication has been finished, then updating record of the time slots now being vacant, the step (g) being to be carried out by the base station, (h) informing the subsidiary station through a C-channel that the requisite number of time slots have been captures, when the base station detects that the requisite number of time slots for making communication through a H-channel has been captured, the step (h) being to be carried out by the base station, and (i) informing the H-channel terminal that it is now possible to make a call, the step (i) being to be carried out by the subsidiary station.

It is preferable that the method further includes the steps (j) recording and reserving time slots now being vacant, on receipt of a request of making a call, from a terminal belonging to a third class among the subscriber class, the step (j) being to be carried out by the base station, (k) identifying classes of subscribers now using a time slot, and mandatorily releasing a time slot between the subsidiary station and the base station first in the first class, and then in the second class, until the requisite number of time slots for making communication through a H-channel is captured, the step (k) being to be carried out by the base station, (1) recording and reserving the thus released time slots, and updating record of the time slots now being vacant, the step (1) being to be carried out by the base station, (m) informing the subsidiary station through a C-channel that the requisite number of time slots have been captures, when the base station detects that the requisite number of time slots for making communication through a H-channel has been captured, the step (m) being to be carried out by the base station, and (n) informing the H-channel terminal that it is now possible to make a call, the step (n) being to be carried out by the subsidiary station.

It is preferable that the method further includes the step (o) informing a subscriber whose time slot has been mandatorily released during communication, that a line is now too busy to make communication, the step (o) being to be carried out by the subsidiary station to a terminal or by the base station to a public network.

It is preferable that the method further includes the steps (p) monitoring time slots now being vacant, on receipt of a request of making a call, from a terminal belonging to the first class, the step (p) being to be carried out by the base station, (q) recording and reserving time slots now being vacant, when the subsidiary station judges that a calling party is a subscriber having high priority, based on a calling party number added to a message of request of making a call, (r) identifying classes of subscribers now using a time slot, and mandatorily releasing a time slot between the subsidiary station and the base station first in the first class, and then in the second class, until the requisite number of time slots for making communication through a H-channel is captured, the step (r) being to be carried out by the base station, (s) recording and reserving the thus released time slots, and updating record of the time slots now being vacant, the step (s) being to be carried out by the base station, (t) informing the subsidiary station through a C-channel that the requisite number of time slots have been captures, when the base station detects that the requisite number of time slots for making communication through a H-channel has been captured, the step (t) being to be carried out by the base station, and (u) informing the H-channel terminal that it is now possible to make a call, the step (u) being to be carried out by the subsidiary station.

It is preferable that the method further includes the step of (v) informing a subscriber whose time slot has been mandatorily released during communication, that a line is now too busy to make communication, the step (v) being to be carried out by the subsidiary station to a terminal or by the base station to a public network.

The advantages obtained by the aforementioned present invention will be described hereinbelow.

The first advantage is that a H-channel transmission line can coexist in transmission lines used for telephone and fax communication, ensuring it possible to efficiently capture time slots used for H-channel communication. Since telephone and fax communication are higher in traffic than H-channel communication, if some channels are used only for H-channel communication, a line usage efficiency would be reduced accordingly. The present invention can avoid such reduction in a line usage efficiency.

The second advantage is that it is possible to present communication service such as multi-media communication even in an area in which a density of population is relatively small. This is because that a multi-way multiplex communication system to which the present invention is applied is often constructed in such an area having a relatively small density of population, and hence, transmission lines between a base station and a subsidiary station are designed relatively small in comparison with the number of subscribers, ensuring a high line-convergence rate to increase a rate at which lines are used. The present invention can increase possibility for establishing a high-rate transmission line such as H-channel.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional multi-way multiplex communication system.

FIG. 2 is a block system of a multi-way multiplex communication system in accordance with the first embodiment of the present invention.

FIG. 3 illustrates a frame of a signal transmitted between a base station and a subsidiary station.

FIG. 4 is a sequence chart for making a call in a H-channel terminal.

FIG. 5 is a sequence chart for making a call in the subscriber class 1.

FIG. 6 is a sequence chart for capturing time slots in the subscriber class 2.

FIG. 7 is a sequence chart for capturing time slots in the subscriber class 3.

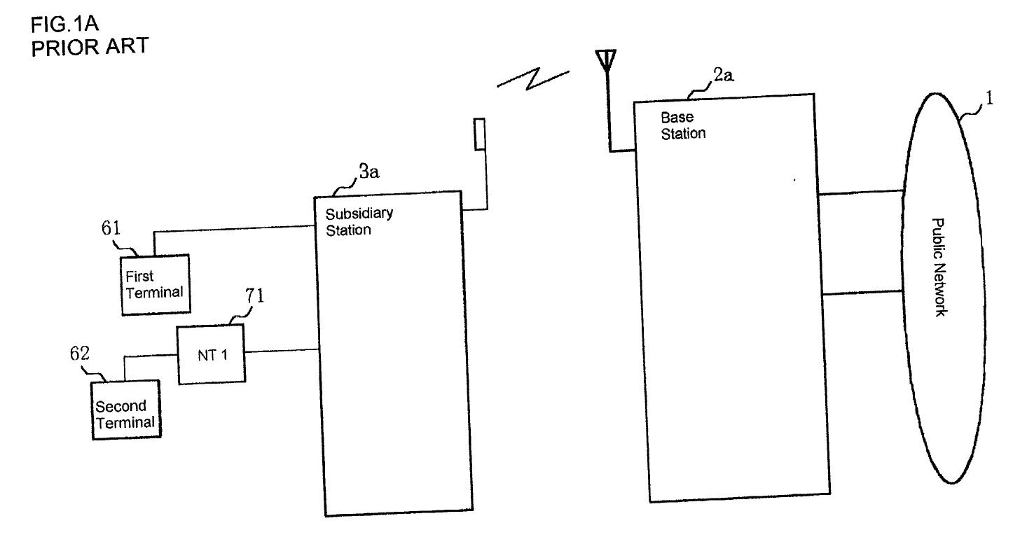

### DESCRIPTION OF THE PREFERRED EMBODIMENTS

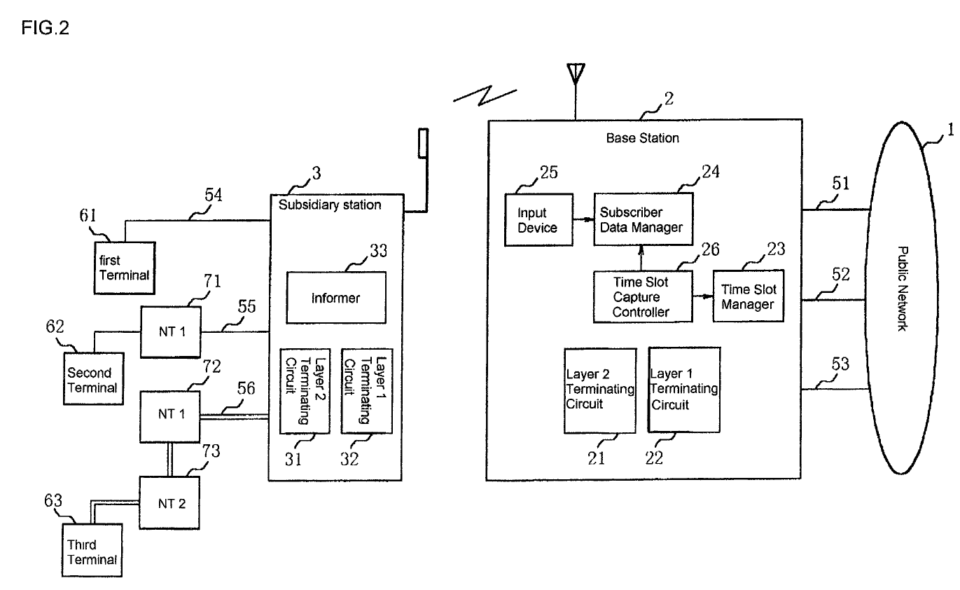

FIG. 2 illustrates a demand-assign type multi-way multiplex communication system in accordance with the first embodiment.

The multi-way multiplex communication system in accordance with the first embodiment is comprised of a base station 2 and a subsidiary station 3.

A first terminal 61 is connected to the subsidiary station 3 through an analog line 54. A second terminal 62 is connected to the subsidiary station 3 through a network terminator 1 (71) through a basic rate interface line 55. A third terminal 63 is connected to the subsidiary station 3 through both a network terminator 1 (72) and a network terminator 2 (73) through a primary rate interface line 56.

The base station 2 assigns the requisite number of time slots to thereby make radio communication with the subsidiary station 3.

The base station 2 is comprised of a time slot manager 23 which manages vacant time slots between the base station 2 and the subsidiary station 3, a subscriber data manager 24 which defines a subscriber class for each of terminals which subscriber class determines an order in using a time slot to make radio communication with the H-channel terminal 63, an input device 25 through which the subscriber class is input to the subscriber data manager 24, a time slot capture controller 26 which, when it is impossible to make a call because of shortage of vacant time slots, controls a time slot, based on the subscriber class defined by the subscriber data manager 24, a layer 1 terminating circuit 21 which terminates a layer 1, and a layer 2 terminating circuit 22 which terminates a layer 2.

Specifically, the time slot capture controller 26 gives up assigning a time slot, waits until one of time slots becomes vacant, or mandatorily interrupts a channel of a subscriber now in communication to thereby make a vacant time slot, in accordance with a class of a subscriber.

The base station 2 is connected to a public network 1 through an analog line 51, a basic rate interface line 52 and a primary rate interface line 53.

The subsidiary station 3 is comprised of an informer 33 which informs the H-channel terminal 63 of whether a call can be made or not, based on information transmitted from the base station 2, a layer 1 terminating circuit 31 which terminates a layer 1, and a layer 2 terminating circuit 32 which terminates a layer 2.

Since the base station 2 includes the layer 1 terminating circuit 21 and the layer 2 terminating circuit 22 and the subsidiary station 3 includes the layer 1 terminating circuit 31 and the layer 2 terminating circuit 32, synchronization in a layer 1 between the base station 2 and the public network 1 and between the subsidiary station 3 and the H-channel terminal 63, and a layer 2 link between the same can be established separately, and in addition, messages in a layer N can be monitored and transmitted, where N is an integer equal to or greater than 3.

The layer 1 terminating circuits 21, 31 and the layer 2 terminating circuits 22, 32 are well known in a field of ISDN communication, and can be accomplished by means of a hardware based on ITU-T standards.

In the demand-assign type multi-way multiplex communication system, the analog line 51, the basic rate interface line 52 and the primary rate interface line 53 all connecting the public network 1 and the base station 2 to each other correspond to the analog line 54, the basic rate interface line 55 and the primary rate interface line 56 each connecting the subsidiary station 3 to the first to third terminals 61 to 63. A channel between the subsidiary station 3 and the base station 2 is established in accordance with demand-assign line control where a channel is assigned when a call is made and a channel is released when communication has been finished.

Accordingly, the number of channels between the base station 2 and the subsidiary station 3 can be set smaller than the number of subscribers in the multi-way multiplex communication system.

The base station 2 monitors a layer 3 signal transmitted through a D-channel in the primary rate interface line 53, and similarly, the subsidiary station 3 monitors a layer 3 signal transmitted through a D-channel in the primary rate interface line 56. For instance, when the subsidiary station 3 detects a request of making a call, transmitted from the H-channel terminal 63 through the primary rate interface line 56, the base station 2 assigns H- and D-channels time slots to the subsidiary station 3, and the subsidiary station 3 makes a request of making a call for the H-channel terminal 63 through the thus assigned D-channel time slot.

Though the ISDN basic rate interface line 55 and the analog line 54 as well as the primary rate interface line 56 are connected to the subsidiary station 3, a transmission line to the public network 1 is established through a transmission line which is common between the base station 2 and the subsidiary station 3.

When the base station 2 receives a request of making a call from the H-channel terminal 63, it might be impossible to capture the requisite number of time slots for carrying out H-channel transmission, because time slots between the base station 2 and the subsidiary station 3 are all used by other subscribers. In order to prevent such a case, priority is determined in advance in accordance with subscriber classes of the H-channel terminal 63, ensuring that the time slot capture controller 26 can capture the requisite number of time slots.

When a subscriber class has first priority, the number of time slots having been already captured and the number of time slots being short of are recorded in the time slot capture controller 26, and the time slot capture controller 26 awaits until time slots now being used are turned vacant. When time slots now being used turns vacant, the time slot capture controller 26 reserves those time slots.

The thus reserved time slots are not assigned even if a request of making a call is made by other subscribers. When the requisite number of time slots for accomplishing H-channel transmission is captured, the H-channel terminal 63 is so informed.

When a subscriber class has second priority, a time slot is assigned to a terminal in urgency. In the second priority, time slots now being used in other subscriber's communication are mandatorily interrupted in a lower priority class, and the thus mandatorily interrupted time slots are used in H-channel communication.

As a result, it is surely possible to capture times slots to be used for high-rate data transmission even in a multi-way multiplex communication system having a high line-convergence rate, preventing an increase in costs and reduction in a line usage efficiency, both caused by an increase in the number of lines used only for H-channel communication.

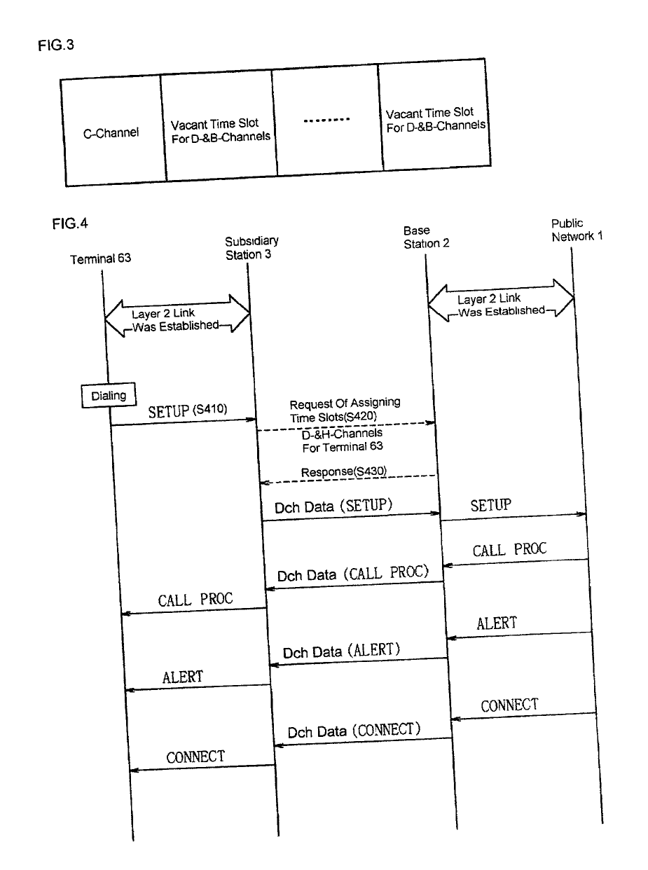

FIG. 3 illustrates a frame of a signal transmitted between the base station 2 and the subsidiary station 3.

The frame repeatedly includes a C-channel, and time slots used for D- and B-channels. A C-channel is a commonly used control channel, and is used for transmitting control data for assigning time slots between the base station 2 and the subsidiary station 3, and data about a D-channel in the basic rate interface and the primary rate interface.

The subsidiary station 3 can transmit and receive voices and data through time slots designated by the base station 2 by virtue of the D-channel's function of transmitting and receiving data.

The base station 2 includes a function of managing a time slot as well as a D-channel's function of transmitting and receiving data. The time slot capture controller 26 in the base station 2 assigns the requisite number of time slots to D- and B-channels, based on the number of vacant time slots recorded in the time slot manager 23 and the subscriber class stored in the subscriber data manager 24.

Hereinbelow is explained an operation of the multi-way multiplex communication system in accordance with the first embodiment.

It is now assumed that the third terminal or H-channel terminal 63 makes a call.

A request of making a call is transmitted to a D-channel in the primary rate interface line 56 through the network terminator 2 (NT2) (73) and the network terminator 1 (NT1) (72), and is detected by the subsidiary station 3. Then, the subsidiary station 3 checks a kind of a required H-channel and the number of time slots necessary for establishing a transmission line, based on information contained in the request, and transmits a request of assigning time slots, to the base station 2.

On receipt of the request of assigning time slots from the subsidiary station 3, the base station 2 checks the time slot manager 23, and compares the number of required time slots and the number of vacant time slots.

If it is possible to capture the required number of time slots, the base station 2 transmits a response to the subsidiary station 3 which response indicates the required number of time slots can be assigned and includes number of time slots to be assigned.

Then, the subsidiary station 3 connects to a channel on the primary rate interface line 56 through the use of the thus assigned time slots to thereby connect a call.

In assignment of H-channel time slots, since some H-channels need a transmission line having a high capacity, it would be necessary to capture time slots between the base station 2 and the subsidiary station 3 in accordance with the capacity.

However, it would be sometimes impossible to capture the requisite number of time slots for accomplishing H-channel transmission, because other subscribers using the analog lines 51, 54 and the ISDN basic rate interface lines 53, 56 also captures time slots between the base station 2 and the subsidiary station 3.

In such a case, the following operation is carried out.

When subscribers or terminals covered by the ISDN primary rate interface is registered, a subscriber class is assigned to each of subscribers, and the thus assigned subscriber class is stored in the subscriber data manager 24.

The subscriber class is grouped into first, second and third classes.

The first class is a class having no priority. If requisite time slots cannot be captured when a call is to be connected, it would be impossible in the first class to establish connection.

The second class is a class where if requisite time slots cannot be captured when a call is to be connected, vacant time slots having been captures are reserved, and when the requisite number of vacant time slots are captured, a subscriber is informed so.

The third class is a class prepared for an urgency. In the third class, if requisite time slots cannot be captured when a call is to be connected, time slots now being used in other subscriber's communication are mandatorily interrupted first in the first class and then in the second class, to thereby capture the requisite number of time slots.

FIG. 4 is a sequence chart showing an operation to be carried out when the H-channel terminal 63 makes a request of making a call.

If the H-channel terminal 63 makes a request of making a call, a request (SETUP) message is transmitted to the subsidiary station 3 from the terminal 63 in step S410.

The subsidiary station 3 has a function of monitoring the layer 3 message. Hence, the subsidiary station 3 reads the request of making a call, transmitted from the H-channel terminal 63, and transmits a request of assigning time slots thereto to the base station 2 through a C-channel, in step S420. This request is a request of assigning C- and B-channels time slots to terminals connected to the subsidiary station 3.

The subsidiary station 3 checks the requisite number of time slots, based on information included in the request of making a call, and adds the number to the request of assigning time slots.

On receipt of the request of assigning time slots, from the subsidiary station 3, the time slot capture controller 26 in the base station 2 checks the number of vacant time slots stored in the time slot manager 23, and judges whether it is possible to capture the required number of time slots. If possible, the base station 2 adds numbers of the captured time slots to a response indicating that the required number of time slots can be assigned, and transmits the response to the subsidiary station 3, in step S430.

When the subsidiary station 3 receives the response from the base station 2, there are established D- and B-channels transmission lines extending between the public network 1 and the H-channel terminal 63.

Hereinbelow is explained an operation in a case where the requisite number of time slots cannot be captured even though the above-mentioned steps are carried out.

It is assumed that when the base station 2 receives a request of assigning time slots, from the subsidiary station 3, time slots between the base station and the subsidiary station 3 are all used by other analog and ISDN subscribers, and hence, it is impossible to capture time slots necessary for accomplishing H-channel transmission.

The time slot capture controller 26 reads a subscriber class assigned to the terminal 63 which made a request of making a call, out of the subscriber data manager 24. The time slot capture controller 26 carries out the following three procedures in accordance with which subscriber class the terminal 63 belongs among the above-mentioned first, second and third classes.

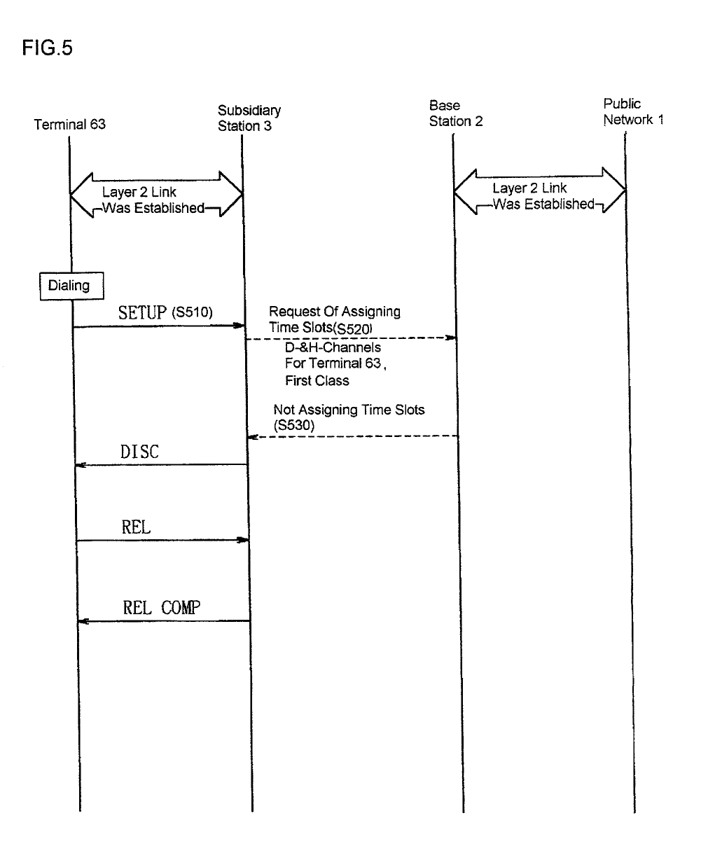

FIG. 5 is a sequence chart showing an operation to be carried out when a request of making a call is made from the terminal 63 belonging to the first class.

If the H-channel terminal 63 makes a request of making a call, a request (SETUP) message is transmitted to the subsidiary station 3 from the terminal 63 in step S510.

The subsidiary station 3 has a function of monitoring the layer 3 message. Hence, the subsidiary station 3 reads the request of making a call, transmitted from the H-channel terminal 63, and transmits a request of assigning time slots thereto to the base station 2 through a C-channel, in step S520.

On receipt of the request, the time slot capture controller 26 informs the subsidiary station 3 that it is impossible to assign time slots, through the response directed to the subsidiary station 3, in step S530. On receipt of the response, the informer 33 in the subsidiary station 3 informs the H-channel terminal 63 that the request of making a call has been rejected.

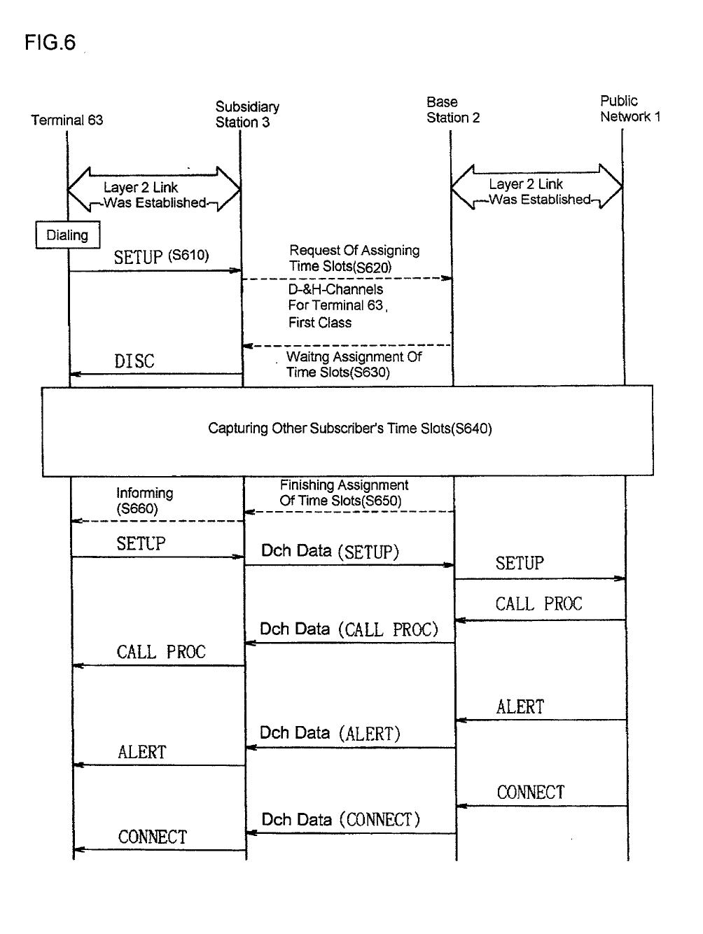

FIG. 6 is a sequence chart showing an operation to be carried out when a request of making a call is made from the terminal 63 belonging to the second class.

If the H-channel terminal 63 makes a request of making a call, a request (SETUP) message is transmitted to the subsidiary station 3 from the terminal 63 in step S610.

The subsidiary station 3 has a function of monitoring the layer 3 message. Hence, the subsidiary station 3 reads the request of making a call, transmitted from the H-channel terminal 63, and transmits a request of assigning time slots thereto to the base station 2 through a C-channel, in step S620.

The time slot capture controller 26 informs the subsidiary station 3 that the time slot capture controller 26 is now waiting assignment of time slots, through the response directed to the subsidiary station 3, in step S630.

Then, the time slot capture controller 26 reserves the captured vacant time slots, and recorded them into the time slot manager 23. The thus reserved and recorded time slots are not assigned, even if a request of making a call is made from the terminals belonging to the first or second classes.

The time slot capture controller 26 monitors time slots now being used. The time slot capture controller 26 captures time slots having been released after communication was finished, and updates data about the vacant time slots, stored in the time slot manager 23, in step S640.

When the time slot capture controller 26 detects that he number of captured time slots reaches the number of time slots necessary for H-channel transmission, the time slot capture controller 26 informs the subsidiary station 3 that the requisite number of time slots has been captured, through a C-channel, in step S650.

Then, the informer 33 in the subsidiary station 3 informs the H-channel terminal 63 that it is now possible to make a call, in step S660.

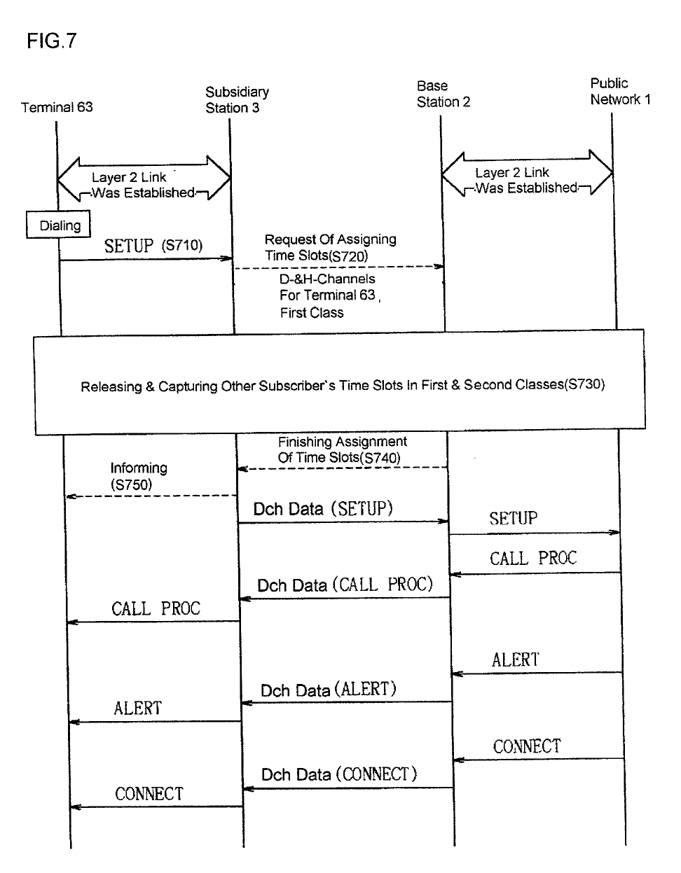

FIG. 7 is a sequence chart showing an operation to be carried out when a request of making a call is made from the terminal 63 belonging to the third class.

If the H-channel terminal 63 makes a request of making a call, a request (SETUP) message is transmitted to the subsidiary station 3 from the terminal 63 in step S710.

The subsidiary station 3 has a function of monitoring the layer 3 message. Hence, the subsidiary station 3 reads the request of making a call, transmitted from the H-channel terminal 63, and transmits a request of assigning time slots thereto to the base station 2 through a C-channel, in step S720.

The time slot capture controller 26 reserves time slots now being vacant, and recorded those vacant time slots into the time slot manager 23. Then, the time slot capture controller 26 reads subscribers now using a time slot and classes of those subscribers out of the time slot manager 23 and the subscriber manager 24, and subsequently, mandatorily releases times slots between the base station 2 and the subsidiary station 3, now being used for communication, first in the first class and then in the second class, until the number of time slots necessary for H-channel transmission is captured, in step S730.

Then, the time slot capture controller 26 reserves the thus released time slots, and updates data about the vacant time slots, stored in the time slot manager 23.

The subsidiary station 3 informs subscribers of the terminals whose time slots have been mandatorily released during communication that a channel is now busy, and hence, communication cannot be made. Similarly, the base station informs subscribers of the public network 1 whose time slots have been mandatorily released during communication that a channel is now busy, and hence, communication cannot be made.

When the time slot capture controller 26 detects that he number of captured time slots reaches the number of time slots necessary for H-channel transmission, the time slot capture controller 26 informs the subsidiary station 3 that the requisite number of time slots has been captured, through a C-channel, in step S740.

Then, the informer 33 in the subsidiary station 3 informs the H-channel terminal 63 that it is now possible to make a call, in step S750.

Hereinbelow is explained a variant of the above-mentioned first embodiment.

As mentioned earlier, a request of making a call, made from a subscriber to which the first class, the lowest class among the subscriber classes, is assigned is rejected, unless the number of time slots necessary for H-channel transmission are vacant. In the variant explained hereinbelow, even such a subscriber can make a call in an urgent case.

When a request of making a call is made from a subscriber belonging to the first class, the subsidiary station 3 judges whether a recipient is an urgent one or not, based on a called party number added to the request.

If the subsidiary station 3 judges that a recipient is an urgent one, the subsidiary station 3 treats the subscriber as a subscriber belonging to the third class, and transmits a request of assigning time slots, to the base station 2.

The time slot capture controller 26 carries out the same procedure as the procedure to be carried out when a request of making a call is made from a subscriber belonging to the third class. That is, the time slot capture controller 26 captures the requisite number of time slots necessary for H-channel transmission.

As mentioned above, it is possible to upgrade the subscriber class in particular communication.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-078507 filed on Mar. 21, 2000 including specification, claims, drawings and summary is incorporated herein by reference in its entirety.

What is claimed is:

1. A multi-way multiplex communication system comprising:
(a) a subsidiary station covering terminals to each of which an analog line, a basic rate interface (BRI) line and a primary rate interface (PRI) line are connected; and
(b) a base station which assigns the requisite number of time slots to thereby make radio communication with said subsidiary station in dependence on the number of vacant time slots between said subsidiary station and said base station,
wherein said base station
(b1) defines a subscriber class which determines an order in using a time slot to make radio communication with a H-channel terminal,
(b2) monitors vacant time slots on receipt of a request of making a call, from said H-channel terminal, and
(b3) controls call connection, based on said subscriber class, when it is impossible to connect a call because of shortage of vacant time slots, thereby ensuring a time slot for said H-channel terminal to make radio communication between said subsidiary station and said base station.

2. A multi-way multiplex communication system comprising:
(a) a subsidiary station covering terminals to each of which an analog line, a basic rate interface (BRI) line and a primary rate interface (PRI) line are connected; and
(b) a base station which assigns the requisite number of time slots to thereby make radio communication with said subsidiary station in dependence on the number of vacant time slots between said subsidiary station and said base station, said subsidiary station including an informer which informs a H-channel terminal of whether a call can be made, based on information received from said base station,
said base station including:
(b1) a time slot manager which manages said vacant time slots;
(b2) a subscriber data manager which defines a subscriber class for each of terminals which subscriber class determines an order in using a time slot to make radio communication with a H-channel terminal;
(b3) an input device through which said subscriber class is input to said subscriber data manager; and
(b4) a time slot capture controller which, when it is impossible to make a call because of shortage of vacant time slots, controls a time slot, based on said subscriber class.

3. The multi-way multiplex communication as set forth in claim 2, wherein said time slot capture controller (c1) gives up assigning a time slot, (c2) waits until one of time slots becomes vacant, (c3) or mandatorily interrupts a channel of a subscriber now in communication to thereby make a vacant time slot, in accordance with said subscriber class.

4. A method of assigning a channel in a multi-way multiplex communication system comprising:
(a) a subsidiary station covering terminals to each of which an analog line, a basic rate interface (BRI) line and a primary rate interface (PRI) line are connected; and
(b) a base station which assigns the requisite number of time slots to thereby make radio communication with said subsidiary station in dependence on the number of vacant time slots between said subsidiary station and said base station,
said method comprising the steps of:
(a) storing a subscriber class into said base station for each of terminals, said subscriber class determining an order in using a time slot to make radio communication with a H-channel terminal;
(b) monitoring vacant time slots on receipt of a request of making a call, from a terminal belonging to a first class among said subscriber class, said step (b) being to be carried out by said base station;
(c) informing said subsidiary station that it is impossible to assign a time slot, when a call cannot be made because of shortage of vacant time slots, said step (c) being to be carried out by said base station; and
(d) informing said H-channel terminal of inability of making a call, said step (d) being to be carried out by said subsidiary station.

5. The method as set forth in claim 4, further comprising the steps of:
(e) informing said subsidiary station that said base station waits being assigned a time slot, on receipt of a request of making a call, from a terminal belonging to a second class among said subscriber class, said step (e) being to be carried out by said base station;
(f) recording and reserving presently vacant time slots, which are not captured even if a request of making a call is received from a terminal belonging to said first and second classes, said step (f) being to be carried out by said base station;
(g) monitoring time slots now being used, and capturing a time slot having been released after communication has been finished, then updating record of said time slots now being vacant, said step (g) being to be carried out by said base station;
(h) informing said subsidiary station through a C-channel that the requisite number of time slots have been captures, when said base station detects that the requisite number of time slots for making communication through a H-channel has been captured, said step (h) being to be carried out by said base station; and
(i) informing said H-channel terminal that it is now possible to make a call, said step (i) being to be carried out by said subsidiary station.

6. The method as set forth in claim 5, further comprising the steps of:
(j) recording and reserving time slots now being vacant, on receipt of a request of making a call, from a terminal belonging to a third class among said subscriber class, said step (j) being to be carried out by said base station;
(k) identifying classes of subscribers now using a time slot, and mandatorily releasing a time slot between said subsidiary station and said base station first in said first class, and then in said second class, until the requisite number of time slots for making communication through a H-channel is captured, said step (k) being to be carried out by said base station;
(l) recording and reserving the thus released time slots, and updating record of said time slots now being vacant, said step (1) being to be carried out by said base station;
(m) informing said subsidiary station through a C-channel that the requisite number of time slots have been captures, when said base station detects that the requisite number of time slots for making communication through a H-channel has been captured, said step (m) being to be carried out by said base station; and
(n) informing said H-channel terminal that it is now possible to make a call, said step (n) being to be carried out by said subsidiary station.

7. The method as set forth in claim 6, further comprising the step of (o) informing a subscriber whose time slot has been mandatorily released during communication, that a line is now too busy to make communication, said step (o) being to be carried out by said subsidiary station to a terminal or by said base station to a public network.

8. The method as set forth in claim 4, further comprising the steps of:
(p) monitoring time slots now being vacant, on receipt of a request of making a call, from a terminal belonging to said first class, said step (p) being to be carried out by said base station;
(q) recording and reserving time slots now being vacant, when said subsidiary station judges that a calling party is a subscriber having high priority, based on a calling party number added to a message of request of making a call;
(r) identifying classes of subscribers now using a time slot, and mandatorily releasing a time slot between said subsidiary station and said base station first in said first class, and then in said second class, until the requisite number of time slots for making communication through a H-channel is captured, said step (r) being to be carried out by said base station;
(s) recording and reserving the thus released time slots, and updating record of said time slots now being vacant, said step (s) being to be carried out by said base station;
(t) informing said subsidiary station through a C-channel that the requisite number of time slots have been captures, when said base station detects that the requisite number of time slots for making communication through a H-channel has been captured, said step (t) being to be carried out by said base station; and
(u) informing said H-channel terminal that it is now possible to make a call, said step (u) being to be carried out by said subsidiary station.

9. The method as set forth in claim 8, further comprising the step of (v) informing a subscriber whose time slot has been mandatorily released during communication, that a line is now too busy to make communication, said step (v) being to be carried out by said subsidiary station to a terminal or by said base station to a public network.
